(19) United States
(12) Patent Application Publication
(10) Pub. No.: US 2011/0187297 A1
(43) Pub. Date: Aug. 4, 2011

(54) SWITCHING DEVICES AND RELATED METHODS

(75) Inventors: Diego N. Guerra, Brighton, MA (US); Matthias Imboden, Boston, MA (US); Pritiraj Mohanty, Los Angeles, CA (US)

(73) Assignee: Trustees of Boston University, Boston, MA (US)

(21) Appl. No.: 13/055,087

(22) PCT Filed: Jul. 21, 2009
(86) PCT No.: PCT/US09/04213

§ 371 Date: Apr. 14, 2011

Related U.S. Application Data
(60) Provisional application No. 61/082,817, filed on Jul. 22, 2008.

(51) Int. Cl. H02K 33/00

(52) U.S. Cl. 318/119

(57) ABSTRACT

A mechanical device capable of switching between two states is described. The device may include a micromechanical resonator with two distinct states in the hysteretic nonlinear regime. The devices can be used as a low-power, high-speed mechanical switch integrated on-chip with silicon circuitry.

### GOVERNMENT SPONSORED RESEARCH

This invention was made with U.S. government support under Grant No. DMR 0449670 awarded by the National Science Foundation. The U.S. Government has certain rights in this invention.

### FIELD OF INVENTION

The invention relates generally to switching devices as well as related methods, and more particularly, to a micromechanical switch driven by a phase modulated signal.

### BACKGROUND OF INVENTION

Switches are one of the most widely used devices in electrical and mechanical devices. A switch is a device that enables a transition between one state to another. For example, a switch can allow a circuit to be turned on or to be turned off. A commonly used switch in modern electronics is the transistor, in which a gate is supplied a certain voltage to activate the transistor and complete the circuit.

As technology is evolving to smaller scale devices (nanotechnology) and faster speeds, the performance requirements for switches are also becoming more demanding. A switch should be capable of transitioning at speeds that allow the rest of the circuit to operate smoothly without any interruption or delays due to the switch. As a result, there is strong interest in designing switches with the required package density and performance to be integrated into various types of circuits.

Since switches are widely used in numerous applications, switch design varies depending on the application and circuit the switch will be integrated in. In memory cells, switches can be used to execute read/write commands and/or to write a “0” or “1” into a memory cell. Several memory cells and/or storage devices, such as magnetic memories, however suffer from problems related to package density and positional and/or static bistability issues when integrating switches into the memory.

### SUMMARY OF INVENTION

Switching devices and related methods are described herein.

According to one aspect, a switching device is provided. The device comprises a mechanical resonating structure configured to generate an output signal. A drive circuit is configured to drive the mechanical resonating structure using a drive signal. The resonating structure has a first response state corresponding to a first output phase of the output signal when driven by a drive signal having a first drive phase and a second response state corresponding to a second output phase of the output signal when driven by a drive signal having a second drive phase.

According to another aspect, a method of switching a first response state to a second response state is provided. The method comprises driving a mechanical resonating structure using a drive signal having a first drive phase to produce a first response state corresponding to a first output phase of an output signal generated by the mechanical resonating structure; and changing a drive phase of the drive signal that drives the mechanical resonating structure to a second drive phase to produce a second response state of the mechanical resonating structure corresponding to a second output phase of an output signal generated by the mechanical resonating structure.

Some embodiments include one or more of the following features. The drive circuit includes an actuation structure. The first output phase and the second output phase are between about 90 degrees and about 270 degrees apart; between about 120 and about 240 degrees apart; or about 180 degrees apart. The resonating structure comprises a suspended beam. The resonating structure has more than two response states. A frequency response of the output signal is non-linear. The mechanical resonating structure is formed of silicon. The device comprises a detection structure. The mechanical resonating structure includes a major element and minor elements coupled to the major element. The mechanical resonating structure is a micromechanical resonating structure. The drive signal comprises more than two drive phases. The output signal comprises more than two output phases.

Other aspects, embodiments and features of the invention will become apparent from the following detailed description of the invention when considered in conjunction with the accompanying drawings. The accompanying figures are schematic and are not intended to be drawn to scale. In the figures, each identical, or substantially similar component that is illustrated in various figures is represented by a single numeral or notation. For purposes of clarity, not every component is labeled in every figure. Nor is every component of each embodiment of the invention shown where illustration is not necessary to allow those of ordinary skill in the art to understand the invention. All patent applications and patents incorporated herein by reference are incorporated by reference in their entirety. In case of conflict, the present specification, including definitions, will control.

### BRIEF DESCRIPTION OF THE DRAWINGS

FIG. 1 includes a micrograph of the device as described in Example 1.

FIG. 2(a) shows the nonlinear response of the beam as a function of the drive amplitude as described in Example 1.

FIG. 2(b) shows the switching between two states in response to a square wave modulation drive phase as described in Example 1.

FIG. 3(a) shows the switching fraction as a function of phase deviation as described in Example 1.

FIG. 3(b) shows the response of a beam for different phase deviations as described in Example 1.

FIG. 4 shows a block diagram of a device according to an embodiment of the invention.

FIG. 5 shows a block diagram of a micromechanical resonating device according to an embodiment of the invention.

FIG. 6 shows a resonating structure according to an embodiment of the invention.

FIG. 7 shows a resonating structure according to an embodiment of the invention.

### DETAILED DESCRIPTION

A mechanical device, as well as related methods, are described herein. According to some embodiments, the device is a switch and can include a mechanical (e.g., micromechanical) resonating structure. As described further below, a drive signal can be used to drive (or actuate) the resonating structure. As described further below, by modifying the phase of the drive signal, the resonating structure can generate different output signals having different phases. The phases can correspond to different response states of the device. For example, the device may have a first response state that corresponds to a first output signal phase, and a second response state that corresponds to a second output signal phase.

Mechanical switching devices at high frequencies are of fundamental and technical interests. A suspended micro- or nanomechanical structure with two distinct excitation states can be used as an archetypal two-state system to study a plethora of fundamental phenomena such as Duffing nonlinearity, stochastic resonance and macroscopic quantum tunneling at low temperatures. From a technical perspective, there are numerous applications in which micro- and nanoscale mechanical structures with two distinct fixed states (static) or resonant states (dynamic) can be used as microwave switches. Since the two states can result in high or low capacitance relative to a fixed electrode, such a device can be used as a switch with high-frequency short or open configurations. In addition, a more tantalizing possibility is their on-chip integration with complementary metal-oxide-semiconductor (CMOS) circuitry.

To be viable for commercial applications, it is preferable for the devices to be operated at room temperature with a manageable, preferably non-magnetic, actuation and detection system. In some embodiments, a micromechanical resonating structure (e.g., a silicon-based resonating structure) may be operating as a two-state system at room temperature with on-chip actuation and detection using standard electrostatic techniques. In some embodiments, switching is induced by modulating solely the phase of the driving force.

In a typical static operation, a suspended structure forming one component of the variable capacitance moves from one fixed position (ON) to a second fixed position (OFF). In the dynamic configuration, the suspended part of the structure continuously vibrates at its resonance frequency or at a frequency within the nonlinear hysteretic regime. The respective ON and OFF configurations are defined by two distinct states, corresponding to two specific amplitudes of vibration. Switching between these two states is achieved using a modulation drive signal. In contrast to varying the amplitude of the modulation, which results in a continuous change in the response amplitude, the methods described herein involve switching as a function of the phase of the drive signal.

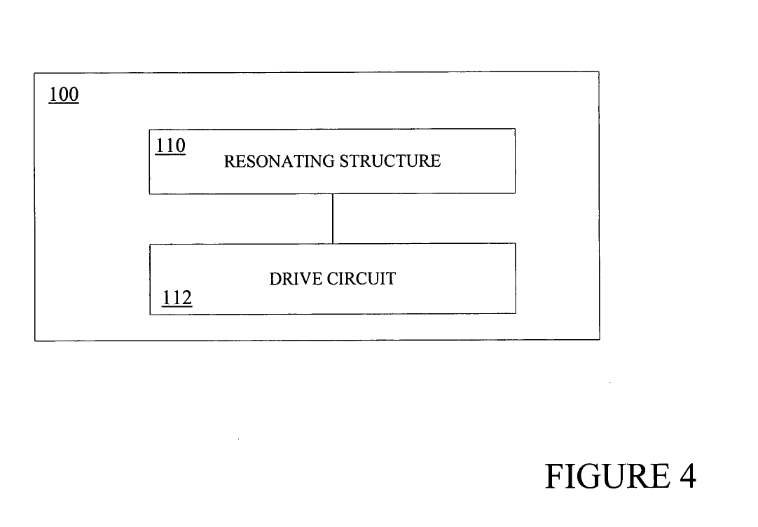

FIG. 4 shows a block diagram of a device 100 according to an embodiment of the invention. The device may be a switch. The device includes a micromechanical resonating structure 110 and a drive circuit 112 coupled to the resonating structure. During use, the drive circuit provides a drive signal that causes the resonating structure to resonate. An output signal from the resonating structure may be generated. The output signal may have a first phase corresponding to a first state of the resonating structure and a second phase corresponding to second state of the resonating structure.

In some embodiments, one or more components of the device are formed from silicon. For example, the micromechanical resonating structure may be formed from silicon.

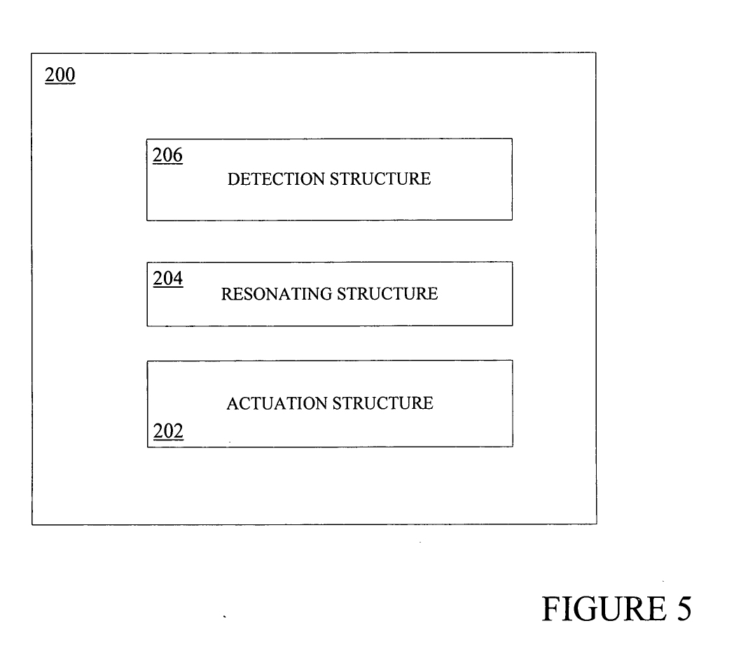

FIG. 5 shows a block diagram of a micromechanical resonating device 200 according to an embodiment of the invention. The device can include an actuation structure 202, a resonating structure 204, and a detection structure 206. In some embodiments, the drive circuitry includes the actuation structure. The device may include one or more active and/or passive circuit components, either as discrete components, an integrated circuit, or any other suitable form, as the various aspects of the invention are not limited to any particular implementation.

The actuation structure 202 is coupled to the resonating structure and is used to drive the resonating structure by actuating (i.e., moving) the resonating structure to vibrate at a desired frequency. In general, any suitable actuation structure and associated excitation technique may be used to drive the resonating structure 204. In some cases, the actuation structure uses a capacitive (i.e., electrostatic) excitation technique to actuate the resonating structure. However, it should be understood that other excitation techniques may be used in certain embodiments, such as mechanical, magnetomotive, electromagnetic, piezoelectric or thermal.

In the embodiments shown, the resonating structure 204 is a micromechanical resonator. Micromechanical resonators are physical structures that are designed to vibrate at high frequencies. Suitable micromechanical resonators have been described, for example, in International Publication No. WO 2006/083482, U.S. patent application Ser. No. 12/028,327, filed Feb. 8, 2008, and in U.S. patent application Ser. No. 12/142,254, filed Jun. 19, 2008, which are incorporated herein by reference in their entireties. In general, a variety of different resonator designs may be used for the resonating structure. For example, the structures may include beams (e.g., suspended beams), platforms and the like; the structures can be comb-shaped, circular, rectangular, square, or dome-shaped, as described further below.

The detection structure 206 detects motion of the resonating structure. In general any suitable structure and associated detection technique may be used. In some embodiments, the detection structure comprises a micromechanical structure. Examples are described further below. In some embodiments, the detection structure may have a structure similar to the actuation structure.

According to some embodiments, the detection structure uses a capacitive (i.e., electrostatic) technique to sense the motion of the resonating structure. However, it should be understood that other detection techniques may be used in certain embodiments such as mechanical, electromagnetic, piezoelectric or thermal.

In some embodiments, the resonating structure may have element(s) (e.g., beam structures) that are on the microscale (i.e., less than 100 micron) and/or nanoscale (i.e., less than 1 micron) dimensions. In some embodiments, at least one of the dimensions of the element(s) is less than 1 micron; and, in some embodiments, the “large dimension” (i.e., the largest of the dimensions) is less than 1 micron. For example, the element(s) may have a thickness and/or width of less than 1 micron (e.g., between 1 nm and 1 micron). Element(s) may have a large dimension (e.g., length) between about 0.1 micron and 10 micron; between 0.1 micron and 1 micron; or, between 1 micron to 100 micron. In some cases, the element(s) can have a width and/or thickness of less than 10 micron (e.g., between 10 nm and 10 micron). In some embodiments, the element(s) may have a length of greater than 1 micron (e.g., between 1 micron and 100 micron); in some cases, the element(s) has a length of greater than 10 micron (e.g., between 10 micron and 500 micron). In some cases, the element(s) have a large dimension (e.g., length) of less than 500 micron. It should be understood that dimensions outside the above-noted ranges may also be suitable.

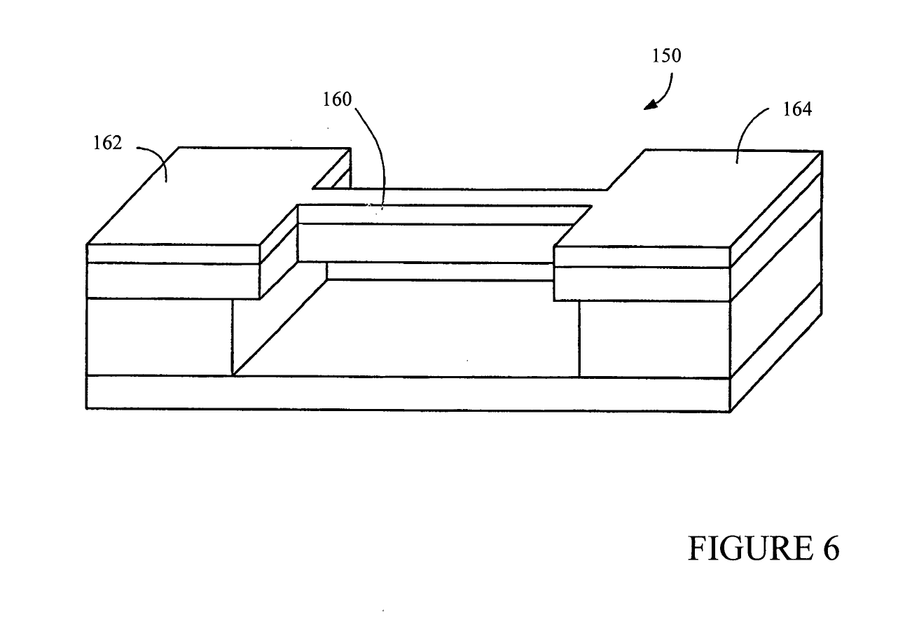

According to some embodiments, as shown in FIG. 6, the resonating structure 150 includes a beam 160. The beam may be clamped at both ends 162, 164. Suitable resonating structures based on beams have been described in U.S. Pat. No. 7,352,608 which is incorporated herein by reference in its entirety.

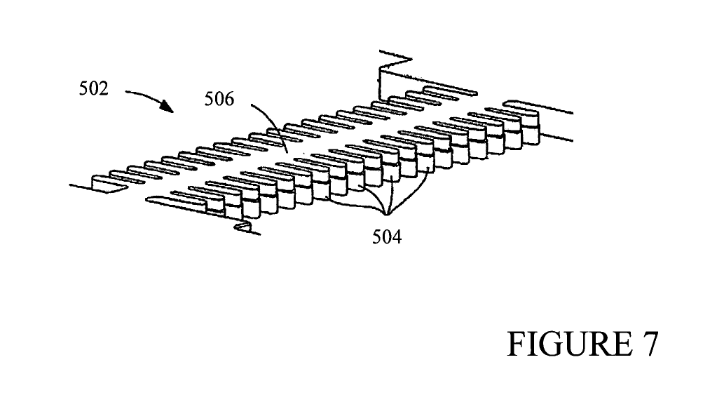

In some embodiments, the resonating structure may have more complex configurations. For example, as shown in FIG. 7, a resonating structure 502 includes multiple minor elements 504 coupled to a major element 506. The minor elements are in the form of cantilever beams and the major element is in the form of a doubly-clamped beam which extends between two supports. Suitable excitation provided by the actuation structure vibrates the minor elements at a high frequency. Vibration of the minor elements influences the major element to vibrate at a high frequency but with a larger amplitude than that of the individual minor elements. Mechanical vibration of the major element may be converted to an electrical output signal which, for example, may be further processed. The frequency produced by the resonating structure can, for example, vary from a few KHz up to 10 GHz, depending on the design and application. Other suitable mechanical resonator designs may be used, including designs with different arrangements of major and minor elements.

Major and minor element dimensions are selected, in part, based on the desired performance including the desired frequency range of input and/or output signals associated with the device. Suitable dimensions have been described in International Publication No. WO 2006/083482 which is incorporated herein by reference above. It should also be understood that the major and/or minor elements may have any suitable shape and that the devices are not limited to beam-shaped elements. Other suitable shapes have been described in International Publication No. WO 2006/083482.

In some embodiments, the minor elements have dimensions in the nanoscale and are thus capable of vibrating at fast speeds producing resonant frequencies at significantly high frequencies (e.g., 0.1-10 GHz). The major element coupled to the minor elements then begins to vibrate at a frequency similar to the resonant frequency of the minor elements. Each minor element contributes vibrational energy to the major element which enables the major element to vibrate at a higher amplitude than possible with only a single nanoscale element. The vibration of the major element can produce an electrical signal, for example, in the gigahertz range (or higher) with sufficient strength to be detected, transmitted, and/or further processed enabling devices to be used in many desirable applications including wireless communications.

In general, the minor elements have at least one smaller dimension (e.g., length, thickness, width) than the major element. Minor elements can have a shorter length than the major element. The minor elements may have nanoscale (i.e., less than 1 micron) dimensions. In some embodiments, at least one of the dimensions is less than 1 micron; and, in some embodiments, the “large dimension” (i.e., the largest of the dimensions) is less than 1 micron. For example, minor elements may have a thickness and/or width of less than 1 micron (e.g., between 1 nm and 1 micron). Minor elements may have a large dimension (e.g., length) between about 0.1 micron and 10 micron; between 0.1 micron and 1 micron; or, between 1 micron to 100 micron. The major element can have a width and/or thickness of less than 10 micron (e.g., between 10 nm and 10 micron). The major element may have a length of greater than 1 micron (e.g., between 1 micron and 100 micron); in some cases, the major element 21 has a length of greater than 10 micron (e.g., between 10 micron and 500 micron). In some cases, the major element has a large dimension (e.g., length) of less than 500 micron. It should be understood that dimensions outside the above-noted ranges may also be suitable.

It should also be understood that the devices may have several configurations and/or geometries. The geometry of the device can include, for example, any antenna type geometry, as well as beams, cantilevers, free-free bridges, free-clamped bridges, clamped-clamped bridges, discs, rings, prisms, cylinders, tubes, spheres, shells, springs, polygons, diaphragms and tori. Any of the mechanical resonating structure and/or coupling elements may be formed either in whole or in part of the same or different geometries. In addition, several different type geometrical structures may be coupled together to obtain particular resonance mode responses. It should be understood that not all embodiments include major and minor mechanical resonating elements. Structures of portions are not limited to beam structures and may be array structures, circular structures, and any other suitable structure.

According to some embodiments, the devices can be used as switches. The switches may be used in numerous applications and may be integrated with other circuit elements. In some cases, the switches may be integrated with filters, memory devices, and/or RF circuits, amongst others.

The following example should not be considered limiting and is provided for illustrative purposes.

### Example 1

This example illustrates formation and characterization of a switching device according to some embodiments of the invention.

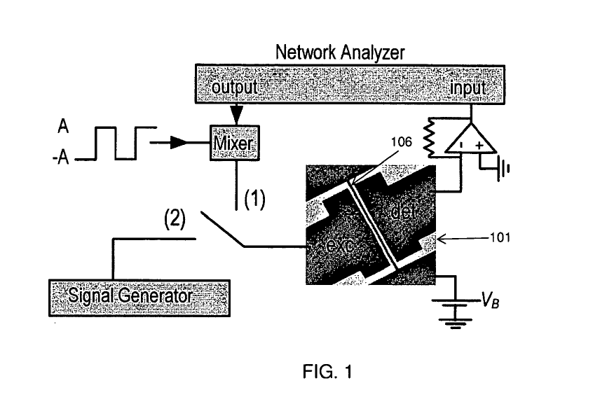

The switching device is fabricated, using standard e-beam lithography and surface nanomachining, from single-crystal silicon using a silicon on insulator (SOI) wafer. FIG. 1 is a circuit schematic illustrating two potential configurations (configurations (1) and (2), described further below) for interconnection of the switching device and surrounding circuitry, and includes a micrograph 101 of the switching device (top view), including an actuation electrode (labeled as “exc”), a detection electrode (labeled as “det”), and the central beam 106, which is 15 μm long, 500 nm thick and 300 nm wide in this example. The gap (g) between the beam and the actuation/detection electrodes is 300 nm. For actuation, the beam is biased with a dc voltage (V_{B}=12 V for the results described in this example) and a megahertz-frequency voltage is applied to one of the side electrodes using a network analyzer (according to configuration (1)) or a signal generator (according to configuration (2)), as shown in FIG. 1. The network analyzer may be a vector network analyzer (e.g., Agilent N3383A) or any other suitable network analyzer. The described excitation scheme produces an in-plane force of magnitude

$$F ( t ) = \frac{1}{2} \frac{d {C}_{1}}{d x} {( {V}_{B} + {V}_{D} cos ( ω t ) )}^{2} + \frac{1}{2} \frac{d {C}_{2}}{d x} {V}_{B}^{2} , \qquad ( 1 )$$

where C₁(C₂) is the capacitance between the beam and the excitation/actuation (or detection) electrode, V_{D} is the drive amplitude, and x is the effective displacement of the beam. Assuming

$$\frac{{d}^{n} {C}_{1}}{d {x}^{n}} = {( - 1 )}^{n} \frac{{d}^{n} {C}_{2}}{d {x}^{n}}$$

for parallel plate capacitor configurations, and expanding this expression in terms of

$$\frac{{V}_{D}}{{V}_{B}} and \frac{x}{g} ( where {V}_{B} ≫ {V}_{D} and g ≫ x )$$

around the equilibrium position (x=0) one obtains

$$F ( t ) \approx {C}^{′} {V}_{B} {V}_{D} cos ( ω t ) + {V}_{B}^{2} ( {C}^{″} x + \frac{1}{6} {C}^{( IV )} {x}^{3} ) , \qquad ( 2 )$$

where

$${C}^{′} = \frac{d {C}_{1}}{d x} {\vert}_{x = 0} = - \frac{d {C}_{2}}{d x} {\vert}_{x = 0}$$

and so on. The oscillating beam produces a time varying capacitance between the beam and the detection electrode, which in the presence of a constant potential creates a current

$$i = \frac{d Q}{d t} = {V}_{B} \frac{d {C}_{2}}{d t} = {V}_{B} \frac{d {C}_{2}}{d x} \dot{x} \approx - {V}_{B} {C}^{′} \dot{x} .$$

This current is amplified using a transimpedance amplifier and measured using a network analyzer (which may be a vector network analyzer). The network analyzer may be set to continuous wave (CW) time mode to measure the time dependence of the beam amplitude and phase at the excitation frequency.

For small drive amplitudes, the expected response as a function of drive frequency is the standard Lorentzian line shape, characteristic of the linear regime with a resonance frequency of

$$\frac{{ω}_{0}}{2 π} = 4.7 MHz$$

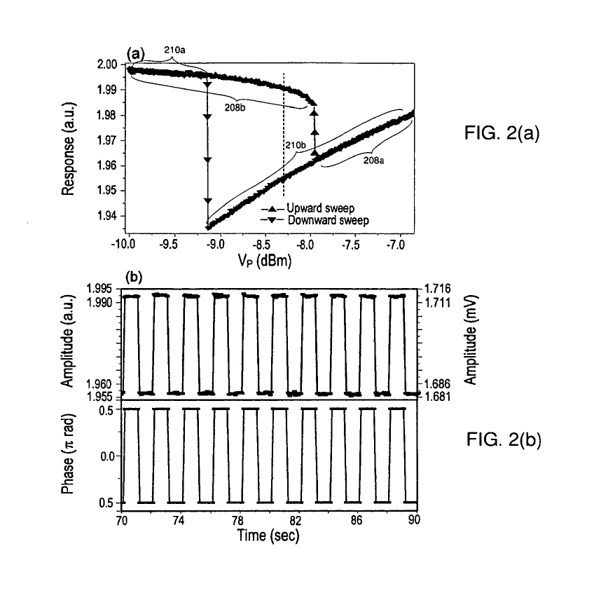

and a quality factor, Q≈100 (at 10⁻³ ton). The value of the loaded Q is limited by the electrical dissipation; hence decreasing the pressure below 1 millitorr does not improve the quality factor (as is expected for an equivalent, unloaded resonator). As the drive amplitude is increased, the beam enters the nonlinear regime. FIG. 2(a) shows the amplitude hysteresis of the beam as a function of the drive amplitude for a fixed frequency of 4.83 MHz, and exhibits a nonlinear response. The response exhibits a range of amplitudes in which the beam is bistable. The upward sweep spans ranges 208a and 208b, while the downward sweep spans ranges 210a and 210b. It should be appreciated that part of range 208b overlaps part of range 210b. In the nonlinear regime, the beam can be described by the Duffing equation with a single degree of freedom,

\ddot{x}+2γ\dot{x}+ω₀²x+k₃x³=f(t), (3)

where γ (dissipation coefficient), ω₀² and k₃ (nonlinear coefficient) are functions of the bias voltage, and f(t) represents the force component with explicit time dependence (see Eq. 2). In this example, the frequency-response curve bends towards higher frequencies with increasing drive amplitude consistent with k₃>0.

Using the setup described in FIG. 1, a voltage

$$V = {V}_{B} + {V}_{D} cos ( ω t + \frac{{ϕ}_{0}}{2} Θ ( Ω ) )$$

is applied on the actuation (alternatively referred to as “excitation”) electrode, where φ₀ is the phase deviation and Θ(Ω) represents a square wave of period

$$\frac{2 π}{Ω} ( Θ ( Ω ) = 1$$

for the first half of the period and −1 for the other half). This voltage produces a force per unit mass

$$f ( t ) = {f}_{D} cos ( ω t + \frac{{ϕ}_{0}}{2} Θ ( Ω ) )$$

where the values of w are chosen to lie in the bistable region. As mentioned, FIG. 1 illustrates two alternative configurations for providing an input signal to the excitation electrode. According to setup (1), the excitation electrode receives a signal from a mixer. The output of the mixer is produced by mixing the output of the network analyzer with a square wave, thus producing a phase modulation with phase deviation π. Using setup (1) (see FIG. 1), the bistable region is measured by sweeping the drive amplitude with a very long modulation period. Subsequently, the amplitude is fixed to a given point (broken line in FIG. 2(a)) and the period of modulation increased (to 2 seconds in this example). The result is presented in FIG. 2(b) where one observes discrete jumps in the beam amplitude, corresponding to two distinct states (upper graph, which shows the switching events), as a consequence of the square wave modulation of the drive phase (lower graph). These jumps are synchronized with the modulating signal and the values of the two amplitude states correspond to the measurements in the hysteresis curve. This phase modulation induced switching is in contrast to the static additive force previously used. The drive amplitude is −8.3 dBm (broken line in FIG. 2(a)) in this example. The described method of using a single signal results in a more stable electric circuit response, hence increasing the control over the switching events and the ease to induce them. The data in FIG. 2 was taken using configuration (1) of FIG. 1.

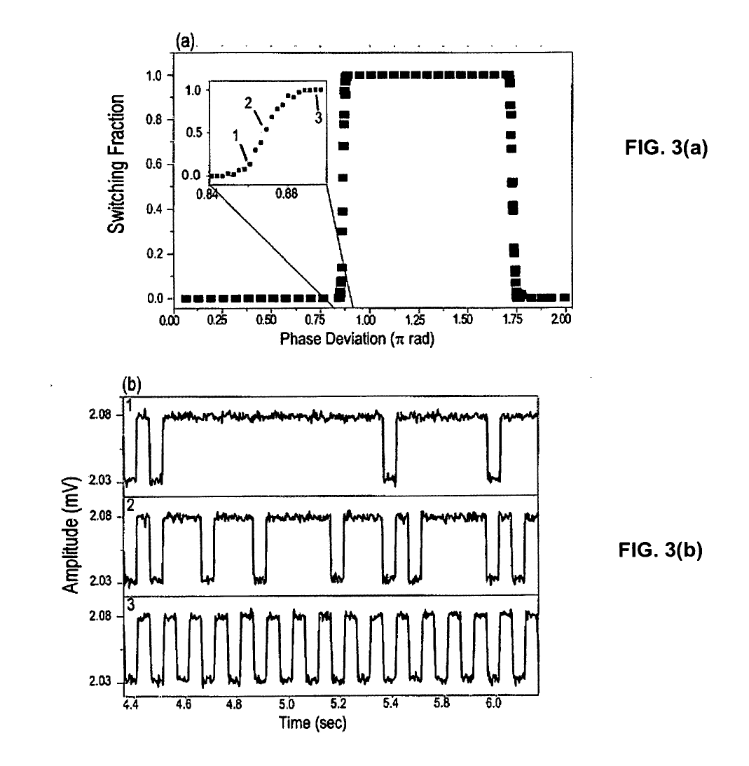

Setup (2), illustrated in FIG. 1, is used to study the dependence of the switching as a function of the phase deviation, where a signal generator is used to drive the beam. In this setup, the signal generator (for example, Agilent 33220A) excites the beam with a variable phase deviation. This allows us to controllably vary the phase deviation. Switching events are observed for values of the phase deviation ranging from 0.9 π to 1.75 π. To measure the fidelity, the switching fraction as a function of the phase deviation is shown in FIG. 3 (a), for which the driving power is −9 dBm at 4.9 MHz. The switching fraction is defined as the number of amplitude switches divided by the number of phase switches. In FIG. 3(b) three time series of switching events are shown for different phase deviations of the modulation (marked in the inset FIG. 3(a)). Graph 1 has a phase deviation of 0.860, graph 2 has a phase deviation of 0.867, and graph 3 has a phase deviation of 0.887 it radians. The modulation frequency is 10 Hz for the three graphs. The data is taken using configuration (2) in FIG. 1. One can see that when the phase deviation in not large enough the beam skips periods, but the successful switches are synchronized with the modulation. For all points in FIG. 3, the modulation frequency

$$\frac{Ω}{2 π} = 10 Hz .$$

No spontaneous switching was observed.

An important feature of a memory (switching) element is the read-write frequency. While the read frequency is given by the resonance frequency with a bandwidth defined by the loaded quality factor, the writing speed is given by the switching frequency. Using the experimental setup utilized here, switching up to ˜1 kHz has been properly measured. For higher speeds, the noise level becomes comparable to the jump size. In theory, the open-loop speed is given by f/Q˜48 kHz.

It is noteworthy that all the observed features of the switching mechanism can be obtained at least qualitatively by simple numerical integration of Equation 3. It is well known that the hysteresis curve (FIG. 2(a)) can be easily reproduced. However, by modulating the phase of the drive one can also obtain switching events with a phase deviation dependency similar to the one reported here (FIGS. 3(a)(b)).

In conclusion, this example shows a fully controllable room-temperature nanomechanical switching element, actuated and sensed using standard electrostatic techniques. Implementing a novel phase modulation scheme, the two states in the hysteretic nonlinear regime of a nanomechanical resonator can be controlled with 100% fidelity. This silicon-based switching device can be fabricated with on-chip CMOS circuitry to provide unprecedented advantages of size and integration.

Having thus described several embodiments of this invention, it is to be appreciated that various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A switching device comprising:
a mechanical resonating structure configured to generate an output signal; and
a drive circuit configured to drive the mechanical resonating structure using a drive signal, wherein the resonating structure has a first response state corresponding to a first output phase of the output signal when driven by a drive signal having a first drive phase and a second response state corresponding to a second output phase of the output signal when driven by a drive signal having a second drive phase.

2. The device of claim 1, wherein the drive circuit includes an actuation structure.

3. The device of claim 1, wherein the first output phase and the second output phase are about 180 degrees apart.

4. The device of claim 1, wherein the resonating structure comprises a suspended beam.

5. The device of claim 1, wherein the resonating structure has more than two response states.

6. The device of claim 1, wherein a frequency response of the output signal is non-linear.

7. The device of claim 1, wherein the mechanical resonating structure is formed of silicon.

8. The device of claim 1, further comprising a detection structure.

9. The device of claim 1, wherein the mechanical resonating structure includes a major element and minor elements coupled to the major element.

10. The device of claim 1, wherein the mechanical resonating structure is a micromechanical resonating structure.

11. The device of claim 1, wherein the first output phase and the second output phase are between about 90 degrees and about 270 degrees apart.

12. The device of claim 1, wherein the drive signal comprises more than two drive phases.

13. The device of claim 1, wherein the output signal comprises more than two output phases.

14. A method of switching a first response state to a second response state, the method comprising:
driving a mechanical resonating structure using a drive signal having a first drive phase to produce a first response state corresponding to a first output phase of an output signal generated by the mechanical resonating structure; and
changing a drive phase of the drive signal that drives the mechanical resonating structure to a second drive phase to produce a second response state of the mechanical resonating structure corresponding to a second output phase of an output signal generated by the mechanical resonating structure.

15. The method of claim 14, wherein the drive signal is provided by a drive circuit.

16. The method of claim 14, the drive circuit includes an actuation structure.

17. The method of claim 14, wherein the first output phase and the second output phase are about 180 degrees apart.

18. The method of claim 14, wherein the resonating structure comprises a suspended beam.

19. The method of claim 14, wherein the resonating structure has more than two response states.

20. The method of claim 14, wherein a frequency response of the output signal is non-linear.

21. The method of claim 14, wherein the mechanical resonating structure is formed of silicon.

22. The method of claim 14, wherein the mechanical resonating structure is a micromechanical resonating structure.

23. The method of claim 14, wherein the first output phase and the second output phase are between about 90 degrees and about 270 degrees apart.

24. The method of claim 14, wherein the drive signal comprises more than two drive phases.

25. The method of claim 14, wherein the output signal comprises more than two output phases.
